(19) United States
(12) Patent Application Publication
(10) Pub. No.: US 2014/0348295 A1
(43) Pub. Date: Nov. 27, 2014

(54) METHOD AND DEVICE FOR INSPECTING THE CARGO SPACE OF A TRUCK

(71) Applicant: SMITHS HEIMANN GMBH, Wiesbaden (DE)

(72) Inventors: Michael JECK, Mainz (DE); Patricia SCHALL, Weiterstadt (DE)

(21) Appl. No.: 14/456,617

(22) Filed: Aug. 11, 2014

Related U.S. Application Data
(63) Continuation of application No. PCT/EP2013/052539, filed on Feb. 8, 2013.

(30) Foreign Application Priority Data
Feb. 10, 2012 (DE) 10 2012 002 484.3

(51) Int. Cl. G01V 5/00; G01S 13/58

(52) U.S. Cl. CPC G01V 5/0066; G01V 5/0041; G01V 5/0033; G01S 13/58
USPC 378/57

(57) ABSTRACT

A methods for inspecting a cargo space of a truck in which the truck is moved past an X-ray source that is switched on while the cargo space is being moved past the source and is switched off while the driver's cab is being moved past the source. The truck is irradiated on one side with electromagnetic radiation, particularly laser beams, having a wavelength between 200 nm and 3000 nm, and the radiation reflected at the transition between the driver's cab and the cargo space is measured in order to determine the switch-on time for the X-ray source.

This nonprovisional application is a continuation of International Application No. PCT/EP2013/052539, which was filed on Feb. 8, 2013, and which claims priority to German Patent Application No. DE 10 2012 002 484.3, which was filed in Germany on Feb. 10, 2012, and which are both herein incorporated by reference.

### BACKGROUND OF THE INVENTION

1. Field of the Invention

The present invention relates to a method for inspecting a truck in which the cargo space of the truck is transilluminated with X-rays while the truck is moved past the X-ray source, and also concerns a device for carrying out the method.

2. Description of the Background Art

In order to inspect trucks for suspicious goods (weapons, explosives, smuggled goods, etc.), it is known to use installations without their own conveyor systems in which a driver drives the truck through the inspection system. If containers are transilluminated as the cargo space, then high-energy X-rays with an energy of greater than 1 MeV must be used, which can also penetrate the driver's cab.

To protect the driver, it is therefore necessary to switch off the X-ray source while the driver's cab moves past it. As soon as the driver's cab has moved past, the X-ray source is switched back on in order to transilluminate the cargo space, for example a cargo container, that follows.

In order to identify the transition between the driver's cab and the cargo space, and thus to determine the switch-on time of the X-ray source, optical methods are known which use light curtains. Since the transition region between the driver's cab and the cargo space is increasingly being covered by aerodynamic fairings, it is no longer possible to determine the switch-on position for the X-rays sufficiently precisely with light curtains.

According to another method, a typical length of the driver's cab is assumed, and transillumination with X-rays begins at a fixed distance from the very front of the truck. This method entails the risk that a part of the cargo space is not transilluminated, and thus is not inspected. If the estimated length of the driver's cab is too short, unintended irradiation of the people in the driver's cab may occur.

A method and a device of the generic type are known from DE 101 22 279 A1, which corresponds to U.S. Pat. No. 7,308,076, which is incorporated herein by reference. This document describes an X-ray system with a shutter for the X-rays, the opening and closing of which is controlled by means of a bar code reader. For this purpose, a bar code is affixed to the cargo space of each truck to be inspected, which bar code triggers the start of the X-ray inspection by causing the shutter to open. Since bar codes must be affixed to each truck as markers, this method is very time-consuming.

### SUMMARY OF THE INVENTION

It is therefore an object of the present invention to provide a method of the generic type such that a precise and fast distinction is made possible between a truck's driver's cab that is not to be transilluminated and its cargo space that is to be transilluminated.

In an embodiment of the invention, in order to determine the switch-on point of the X-ray source, the truck is irradiated on one side with electromagnetic radiation, in particular laser beams, having a wavelength between 200 nm and 3000 nm, and the radiation reflected at the transition between the driver's cab and the cargo space is measured.

The invention makes use of the circumstance that the driver's cab and the cargo space of a truck generally are bounded by metal walls. In contrast, aerodynamic fairings at the transition between the driver's cab and the cargo space generally are made of plastic-based materials, such as glass fiber reinforced plastics (GFRP), whose reflection behavior is different for the electromagnetic radiation employed.

Preferably, laser beams having a wavelength between 600 nm and 1000 nm, more particularly between 880 nm and 950 nm, are used for determining the switch-on point.

In advantageous fashion, laser diodes are used to generate the laser beams.

Rotary laser scanners, in which the measurement sensors are integrated into the housing of the laser source, have proven to be especially suitable.

Preferably, the speed of a truck passing by can be determined by means of an additional radar sensor. In this way, distortions in determining the switch-on point resulting from speed fluctuations can be corrected.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a rough schematic side view of a truck;

FIG. 2 shows a principle of operation of a device according to an embodiment of the invention; and

FIG. 3 shows a principle of operation of a device according to an embodiment of the invention.

### DETAILED DESCRIPTION

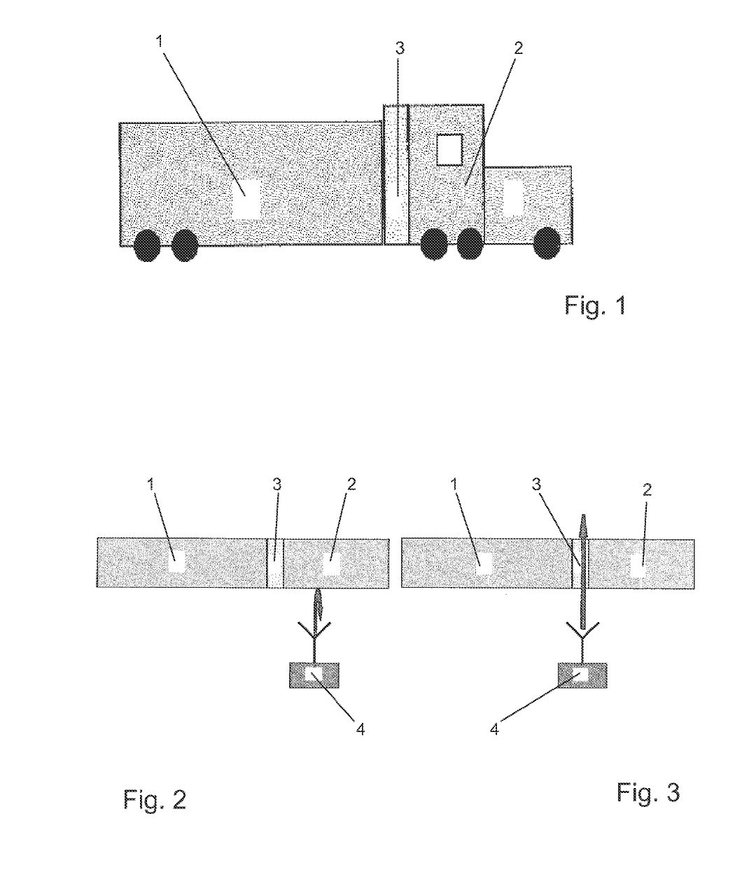

In FIG. 1, a truck is shown that includes a cargo space 1, a driver's cab 2, and a transition region 3 between the driver's cab 2 and the cargo space 1. The transition region 3 is aerodynamically faired to reduce air resistance. The aerodynamic fairings are made of plastic-based materials, for example glass fiber reinforced plastic (GFRP), which are optically impermeable to electromagnetic radiation in the visible range.

To inspect the truck for suspicious goods (weapons, explosives, smuggled goods, etc.), the truck is moved through an X-ray inspection installation such as is described in DE 101 22 279 A1, for example. The X-ray inspection installation, not shown in the drawing, contains an X-ray source and a detector arrangement aimed at the X-ray source, with a travel lane for the truck located between them. The X-ray source emits X-rays with sufficiently high energy of greater than 1 MeV so that even metal cargo containers can be transilluminated for inspection.

Preferably, the truck drives through the X-ray inspection installation under its own power. Thus, the driver drives the truck along the travel lane between the stationary X-ray source and the stationary detector arrangement and passes by them. To protect the driver, it is necessary for the X-ray source to be switched off while the driver's cab moves past it. Immediately after the driver's cab has passed the radiation area, the X-ray source must be switched on so that even the start of the cargo space is inspected.

To determine the switch-on time of the X-ray source, the truck is irradiated on one side with electromagnetic radiation, in particular laser beams, having a wavelength between 200 nm and 3000 nm, until the transition region between the driver's cab and the cargo space is detected, and it is thus certain that the driver's cab has passed. For detection, the radiation reflected by the truck is measured, at least until the transition between the driver's cab and the cargo space. Preferably, the irradiation takes place with laser beams having a wavelength between 600 nm and 1000 nm, more particularly between 880 nm and 950 nm. This radiation can penetrate the plastic material of a fairing to a large extent, while it is largely reflected by components made of metal. In advantageous manner, laser diodes are used as laser sources.

Preferably, rotary laser scanners are arranged on one side of the travel lane that extends between the X-ray source and the associated detector arrangement. In rotary laser scanners the measurement sensors are integrated into the housing of the laser source. Rotary laser scanners with an IR laser (880 nm-950 nm, for example 905 nm), an angular range of 270 degrees at an angular resolution of 0.5 degrees, and a scanning frequency of 50 Hz, which are located at a distance between 0.5 m and 20 m from the truck, have proven to be especially suitable.

In the installation as shown in FIGS. 2 and 3, a rotary laser scanner 4 with a transmitting and receiving unit is arranged on one side of the travel lane. The laser scanner 4 is arranged along the travel lane such that it is located in the region of the beginning of the driver's cab 2 at the start of measurement. Its lateral distance from the travel lane is approximately 3 m. The length of the driver's cab 2, the length of a cargo container as the cargo space 1, and the length of the vehicle as a whole can be determined with this arrangement.

The measured reflection power is high as long as radiation is reflected by the metallic driver's cab 2 or a metallic cargo space 1 such as a cargo container.

As soon as the transition region between the driver's cab 2 and cargo space 1 enters the beam path, the received reflection power drops significantly. As is shown in FIG. 3, the plastic-based fairing of the truck in the transition region 3 allows the great majority of the radiation to pass through without reflecting it. As soon as the received power subsequently decreases substantially, the X-ray radiation can be switched on, since the driver's cab 2 is no longer located in the beam path of the X-ray radiation.

In order to be able to correct for distortions in receiving the transmitted or reflected electromagnetic radiation caused by speed fluctuations of the truck, an additional radar sensor that determines the speed of the truck traveling past is preferably arranged in the X-ray inspection installation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for inspecting the cargo space of a truck, the method comprising:
moving the truck past an X-ray source that is switched on while the cargo space is being moved past the X-ray source and is switched off while a driver's cab is being moved past the X-ray source;
irradiating the truck on one side with electromagnetic radiation that are generated by laser beams having a wavelength between 200 nm and 3000 nm; and
measuring the electromagnetic radiation reflected at a transition between the driver's cab and the cargo space to determine a switch-on point of the X-ray source.

2. The method according to claim 1, wherein laser beams having a wavelength between 600 nm and 1000 nm or between 880 nm and 950 nm are used.

3. The method according to claim 1, wherein laser diodes are used to generate the laser beams.

4. The method according to claim 1, wherein a rotary laser scanner in which measurement sensors are integrated into a housing of a laser source.

5. The method according to claim 1, wherein a speed of the truck passing by is determined via a radar sensor.

6. A device for carrying out the method according to claim 1, the device comprising:
at least one X-ray source;
a detector arrangement aimed at the X-ray source, between X-ray source and the detector arrangement a travel path for a truck is arranged;
a source for laser beams having a wavelength between 200 nm and 3000 nm, is aimed at a truck and is arranged on one side of the travel lane; and
a sensor for receiving reflected laser beams is located on the same side of the travel lane.

7. The device according claim 6, wherein the X-ray source emits laser beams having a wavelength between 600 nm and 1000 nm or between 880 nm and 950 nm.

8. The device according to claim 6, wherein laser diodes generate the laser beams.

9. The device according to claim 6, further comprising a rotary laser scanner in which at least one measurement sensor is integrated into a housing of the laser source.

10. The device according to claim 6, further comprising a radar sensor for determining a speed of a truck passing by.
